(19) United States
(12) Patent Application Publication
(10) Pub. No.: US 2007/0149902 A1
(43) Pub. Date: Jun. 28, 2007

(54) Human joint rehabilitation apparatus

(76) Inventor: Jeffrey R. Besendorfer, Heber, UT (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 11/713,331

(22) Filed: Mar. 2, 2007

Related U.S. Application Data
(63) Continuation-in-part of application No. 10/950,850, filed on Sep. 27, 2004.

(51) Int. Cl. A61H 1/02; A61H 1/00; A61H 5/00

(52) U.S. Cl. 601/23; 601/33

(57) ABSTRACT

A human joint rehabilitation apparatus, the apparatus includes a movable platform configured to support a portion of a patient's body including the joint, and a motorized mechanical energy source configured to move at least a portion of the platform to apply motion to the joint, wherein the patient dynamically controls the motorized mechanical energy source to operate the motion of the joint.

### CROSS REFERENCE TO RELATED APPLICATIONS

The present application is a continuation-in-part of U.S. patent application Ser. No. 10/950,850, filed Sep. 27, 2004 to Bessendorfer, et. al., which is herein incorporated by reference in its entirety.

### BACKGROUND

Continuous passive motion or manually applied physical therapy to an injured or post operative limb is the primary rehabilitative treatment chosen by most doctors and therapists. Many limb and joint exercising devices are known. Generally, these machines have a motor driven limb support, with the limb support capable of being set to periodically move the limb in a preset range of positions, for a preset length of duration, and at a preset speed. Once these angles, speed, and duration have been chosen, the machine automatically moves the limb from a straightened position back and forth into these pre-chosen positions at the pre-chosen speed for the pre-chosen duration.

Resetting positions and safety cutoffs are available for the user of current machines. However, because all variables are preset and constant, typically, initial therapy cycles of the machine are often too severe and painful, whereas, later therapy cycles are insufficient due to the limbering of the joint and the joint's capability of greater movement as the therapy session progresses. Further, current machines do not allow for total joint isolation, but often require the use of other joints to achieve joint movement (such as hip joint movement in the case of the knee).

Current machines and therapists do not sense the pain of the patient at all and do a limited job of sensing joint stiffness. A machine is needed that will allow total flexibility in the treatment of a joint, including flexion, extension, rotation, duration, and speed, but in doing so, the machine needs to be sensitive to the pain threshold of the patient and the flexibility of the joint being rehabilitated.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 illustrates a schematic diagram of an exemplary joint rehabilitation apparatus.

FIG. 2 illustrates a perspective view of an exemplary joint rehabilitation apparatus configured to rehabilitate knee joints.

FIG. 3A illustrates a top view of an exemplary main frame.

FIG. 3B illustrates a side view of an exemplary main frame.

FIG. 4 illustrates an exemplary leg support assembly.

FIG. 5 illustrates an exemplary drive train assembly.

FIGS. 6A and 6B illustrate an exemplary patient-operated control assembly.

FIGS. 7A and 7B illustrate an exemplary joint rehabilitation apparatus configured to rehabilitate hip joints.

FIGS. 8A and 8B illustrate an exemplary joint rehabilitation apparatus configured to rehabilitate shoulder joints.

Throughout the drawings, identical reference numbers designate similar, but not necessarily identical, elements.

### DETAILED DESCRIPTION

A joint rehabilitation apparatus is provided herein that allows for goal setting and attainment by the user. The machine allows for full extension and substantially full flexion of a substantially fully isolated joint. In some embodiments the machine also allows for the controlled rotation of a joint, such as a ball and socket joint. The machine makes therapy more effective and more efficient by putting greater control in the hands of the patient. This machine is useful for the treatment of several conditions, including, but not limited to, intra-articular knee fracture, reconstructed knee ligaments, total knee joint arthroplasty, rotator cuff injuries, tendinitis, bursitis, osteoarthritis, shoulder surgeries, shoulder fractures, shoulder replacements, joint subluxations, joint dislocations, hyperlaxity, structural impingements, functional impingements, microtrauma induced injuries, macrotrauma induced injuries, hip pointers, iliotibial band syndrome, sciatic nerve damage or injury, Legg Calvé Perthe Disease, slipped capital femoral epiphysis, hip surgeries, hip fractures, stress fractures, avascular necrosis, hip replacements, and any other conditions requiring range of motion to be re-established or maintained.

In one exemplary embodiment, the joint rehabilitation apparatus allows the passive exercising of a joint. The exemplary joint rehabilitation apparatus has a table for sitting, to which is attached a motorized mechanical energy source and a limb support mechanism. The motorized mechanical energy source is attached through a power transmission system to the limb support mechanism. When the patient manipulates a dynamic control system, angular motion of the limb support mechanism is precisely controlled so that the patient can easily move his/her own limb through a substantially full range of motion (full extension to substantially full flexion) and/or joint rotation, at a desired speed and hold a position of flexion or extension or at an angle of joint rotation for a desired duration, thereby managing the personal factors of pain and stiffness. Substantially complete isolation of the joint is maintained throughout the flexion, extension, or rotation cycle.

Recognizing that this apparatus may be configured to work with many different joints such as knee joints, shoulder joints, hip joints, elbow joints, and back joints, and powered in many different ways, a general joint rehabilitation apparatus will first be discussed, followed by a brief discussion of a joint rehabilitation apparatus configured for exercising knee joints. Thereafter, the individual sub-assemblies of the joint rehabilitation apparatus will be discussed in detail, including the main frame, the leg support assembly, the drive train assembly, and the patient-operated dynamic control system.

As used in the present specification and appended claims, the terms “dynamic control” and “dynamically controls” refer to the ability of a patient or user to actively control a joint rehabilitation apparatus according to the present specification during flexion, extension and joint rotation exercises. A patient that dynamically controls a joint rehabilitation apparatus accordingly has the ability to control parameters such as starting time, stop time, hold time, angle of flexion, angle of extension and angle of joint rotation during an exercise or therapy session. Furthermore, the terms “dynamic control” and “dynamically controls” imply that a user is not confined to operating a joint rehabilitation apparatus only under operating parameters set at the beginning of the rehabilitation or exercise session.

In the following description, for purposes of explanation, numerous specific details are set forth in order to provide a thorough understanding of the present method and apparatus. It will be apparent, however, to one skilled in the art, that the present method and apparatus may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Schematic Diagram of a Joint Rehabilitation Apparatus

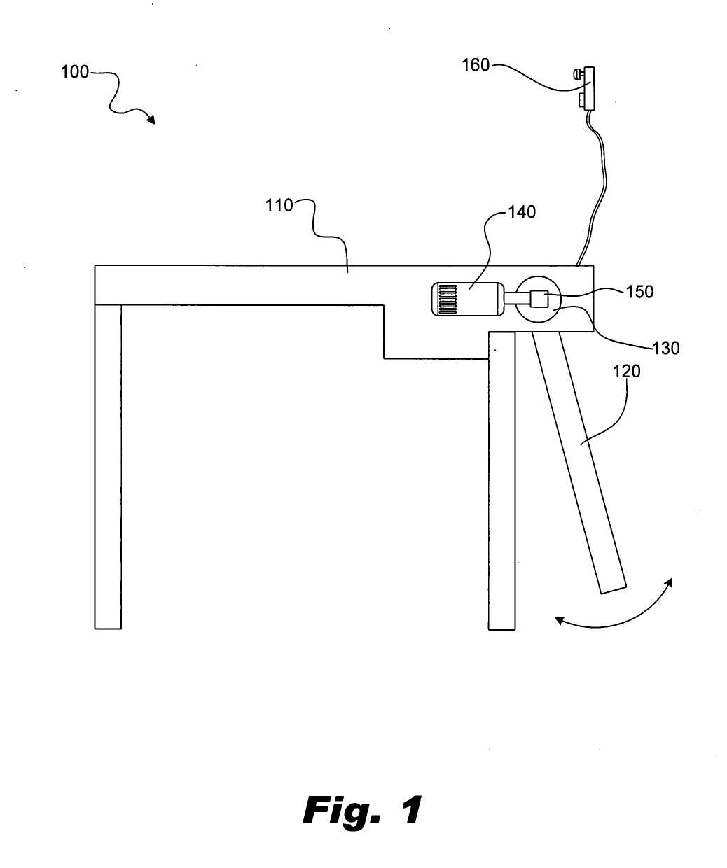

FIG. 1 is a general schematic view of a joint rehabilitation apparatus (100). The joint rehabilitation apparatus (100) generally includes an upper-limb support (110) such as a table and a lower-limb support (120). The lower-limb support (120) pivots with respect to the upper-limb support (110). Further, the lower-limb support (120) is configured to have a lower part of the limb attached thereto, such that as the lower-limb support (120) is rotated, the lower part of the patient's limb follows. As the lower part of the patient's limb follows the movement of the lower-limb support, the joint is exercised. The motion of the joint as the limb is drawn back on itself is referred to as flexion while the motion of the limb as it is straightened is referred to as extension. The joint may also be rotated with respect to an upper limb, a lower limb or the patient's body. The range between flexion, extension and angular rotation is referred to as range of motion. By independently supporting the upper and lower portions of the patient's limb, the lower portion of the limb alone may be moved through the range of motion, thereby substantially isolating the movement of the joint from the movement of other joints in the limb.

This isolation of the joint to be rehabilitated is further enhanced by providing a motive force separate from the patient's own exertion with respect to the limb and joint to be rehabilitated. For example, if the patient is exercising a knee, the joint rehabilitation apparatus moves the lower leg while minimizing or eliminating the need for the patient to use his/her leg muscles to move the lower leg. The rotational force used to move the lower-limb support (120) may be applied to a pivot (130) that is coupled to the lower-limb support (120).

Further, this motive force is generated by a motorized mechanical energy source such as an electric motor (140), and manipulated through the use of a patient-operated dynamic control system (160). The output of the electric motor (140) may then be transferred from the electric motor (140) to the pivot (130) through a power transmission assembly (150). Accordingly, the joint rehabilitation apparatus (100) is configured to be driven by the electric motor (140) and controlled by the patient-operated dynamic control system (160) while allowing the joint to be exercised in isolation. The joint rehabilitation apparatus such as the one shown (100) may be configured to be used with any joint to be rehabilitated.

It should be understood that other motorized mechanical energy sources may be used to provide the aforementioned motive force. Some examples of motorized mechanical energy sources that may be used in conjunction with apparatus of the present specification include, but are not limited to, motorized hydraulic mechanical energy sources and motorized pneumatic mechanical energy sources.

An exemplary joint rehabilitation apparatus (200) will now be discussed in the context of exercising a knee joint.

Joint Rehabilitation Apparatus

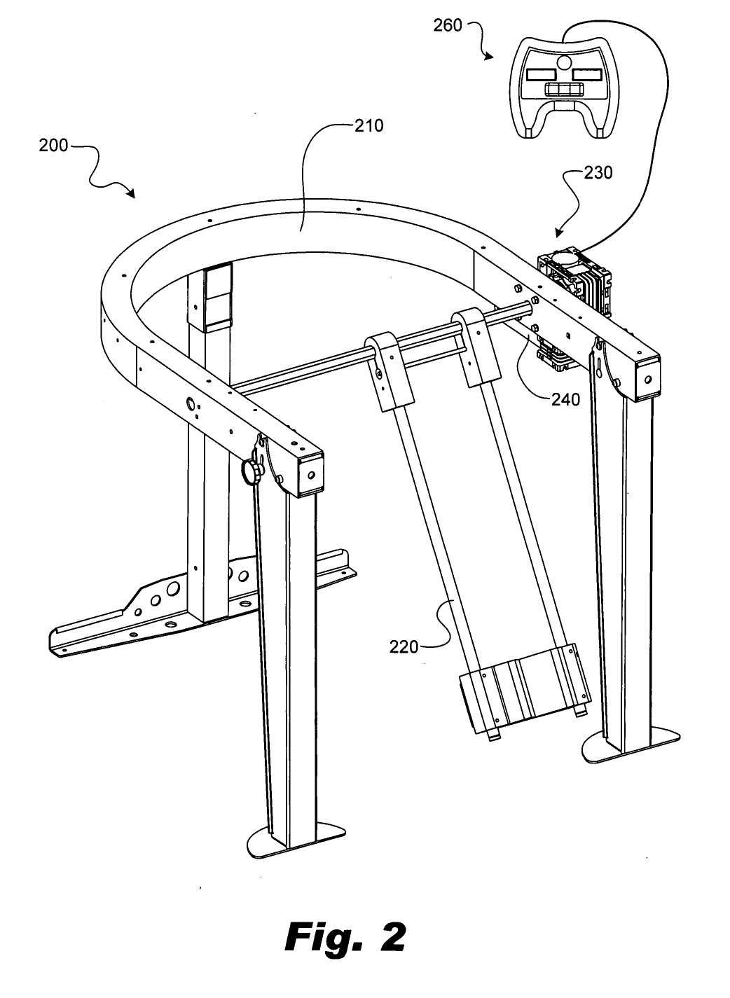

FIG. 2 illustrates one exemplary joint rehabilitation apparatus (200) that generally includes a support table main frame (210), a leg support assembly (220), a drive train assembly (230), and a patient-operated dynamic control system (260). The main frame (210) is coupled to the leg support assembly (220) and the drive train assembly (230). The patient-operated dynamic control system (260) is in electrical communication with the drive train assembly (230), thus enabling the viewing of data and manipulation of the drive train assembly (230) comfortably by the patient while seated on the joint rehabilitation apparatus (200).

In particular, the leg support assembly (220) is pivotably supported on one end thereof to the main frame (210) and is rotatingly coupled on the other end to the drive train assembly (230). The drive train assembly (230) is then connected to the main frame (210).

The drive train assembly (230) translates the rotation of an electric motor (240), preferably at a substantially reduced ratio, to rotation in the leg support assembly (220). This rotation is accomplished while isolating a single joint and allowing the user to control the range of motion with respect to flexion and extension; speed; and duration, in light of personal factors such as pain and stiffness by using the patient-operated dynamic control system (260). For ease of reference, the joint rehabilitation apparatus will be discussed with reference to the rehabilitation or therapy of a knee joint.

Each of the assemblies includes several components. Accordingly, each assembly will be discussed in more detail. In particular, the components of the main frame (210) will be discussed first, followed by a discussion of the leg support assembly (220), the drive train (230), and the patient-operated dynamic control system (260).

Main Frame

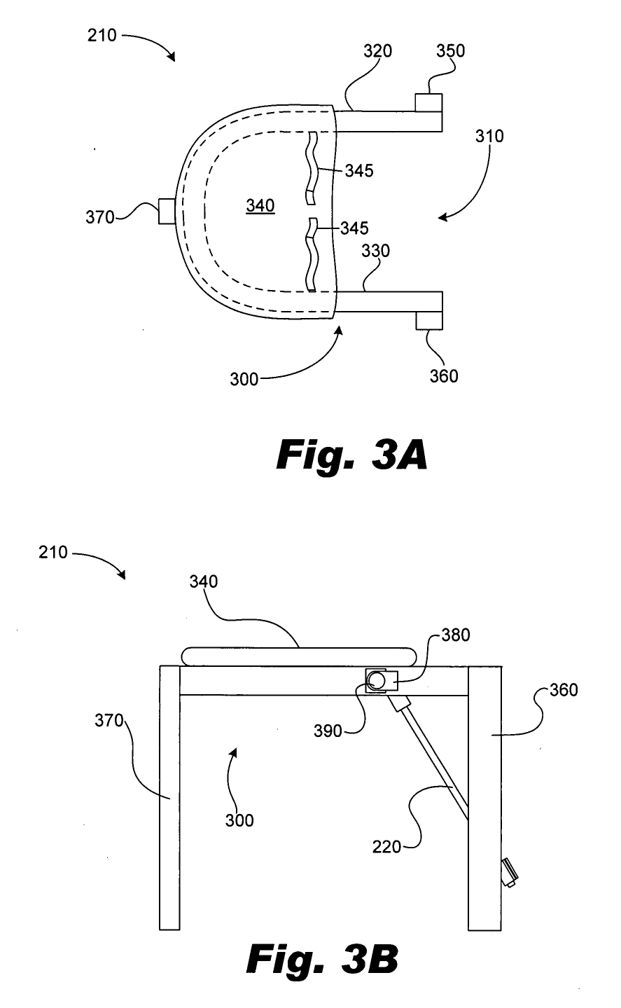

FIGS. 3A and 3B illustrate the main frame (210). The main frame (210) includes a generally U-shaped sub-frame (300). Accordingly, a gap (310) is defined between opposing arms (320, 330) of the table portion (300). The gap (310) of the exemplary main frame (210) is sized to allow at least one leg to be positioned within the main frame (210) and may be sized to allow both legs to be positioned within the main frame.

The main frame (210) may include a support, such as a generally flat table (340) that extends between the opposing arms to support a patient thereon. In such a configuration, the patient would sit on the table (340) and place the knee to be rehabilitated near the end of the table (340) and within the gap (310). The thigh of the knee to be rehabilitated would be held still by straps (345) attached to the table (340). Consequently, the lower part of the leg would extend beyond the table (340) such that the lower part of the leg would be suspended by the table (340). For convenience, the gap (310) may be sized to allow the patient to extend both legs from the table (340).

The configuration of the main frame (210) helps ensure that the patient is able to move the knee through a substantially full range of motion while minimizing contact between the leg and the ground or other surfaces. The exemplary main frame (210) shown is configured to allow a patient to rest both legs on the table (340), such that the knees are near the end of the table (340) and the lower legs are suspended.

The main frame (210) also includes three legs (350, 360, 370) that support the U-shaped sub-frame (300). These legs (350, 360, 370) are sufficiently long to ensure that the lower portion of the patient's leg does not come into contact with the ground or other surfaces as it moves through its range of motion. In addition, the legs (350, 360, 370) fold up such that the apparatus (100) may be more easily stored or transported. One leg may be configured for removal and use as a transport handle for the apparatus (200)

A feedback mechanism such as an optical incremental encoder reader (380) may be attached to the main frame (210). A corresponding disk (390) may be included attached to the leg support assembly (220) such that any movement of the leg support assembly (230) in relation to the main frame (210) transmits shaft rotation data, such as flexion and extension angle, speed of movement, direction of movement, time duration of flexion and extension exercises, and torque to the patient-operated dynamic control system (260). In this way the data may be easily viewed by the patient. The encoder reader (380) and disk (390) may also be attached at various other points on the drive train assembly (230) and main frame (210). In some embodiments, other feedback mechanisms may provide these data to the patient.

Accordingly, the main frame (210) provides a stable platform to support the joint to be rehabilitated while providing a substantially full range of motion. The main frame (210) is also configured to support the leg support assembly (220) and the drive train assembly (230) in addition to providing a connection point for the patient- operated dynamic control system (260).

Leg Support Assembly

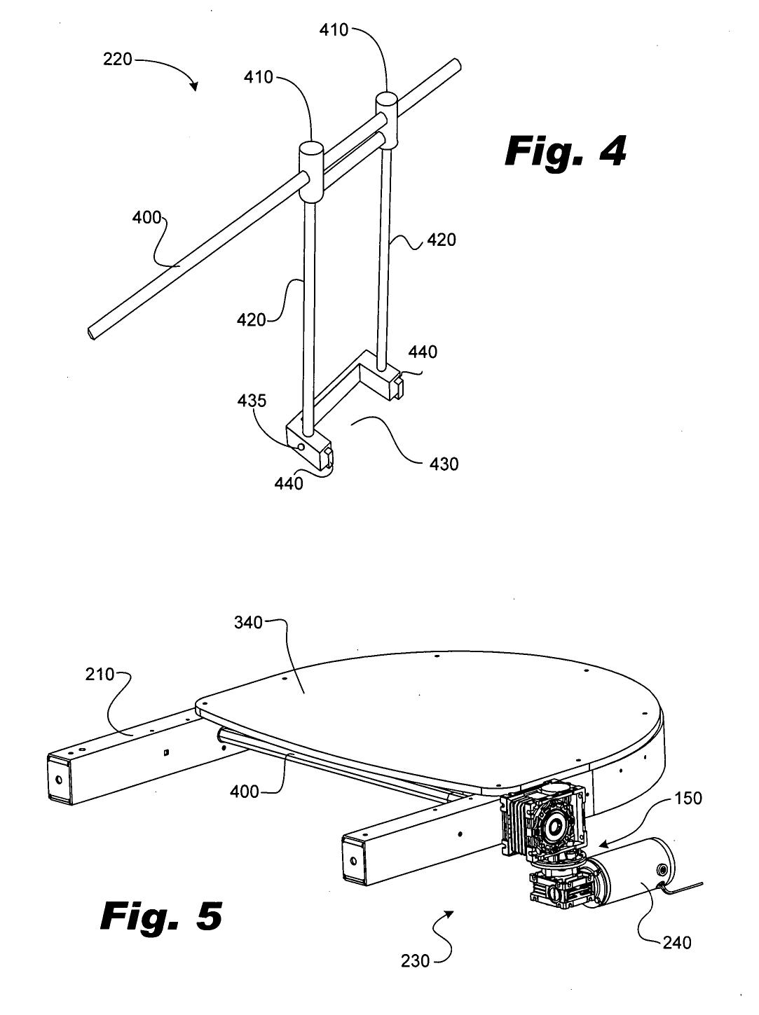

FIG. 4 illustrates the leg support assembly (220) in more detail. The leg support assembly (220) includes lateral adjustments and radial adjustments. These adjustments allow the joint rehabilitation apparatus (200; FIG. 2) to be adapted for use with either leg and for use by patients having limbs of different dimensions. The leg support assembly (220) includes a hexagonal drive shaft (400), shaft sleeves (410), opposing parallel guide rods (420), and a limb attachment mechanism (430).

The shaft sleeves (410) shown slides on bushings which allow the shaft sleeves (410) to be moved laterally along the drive shaft (400). This configuration allows the shaft leg support assembly (220) to be positioned to allow the patient to exercise either leg. For example, if the patient desires to exercise the left knee, the shaft sleeves (410) are moved along the drive shaft (400) until it is in position with respect to the left knee. Accordingly, the mobility of the shaft sleeves allows a patient to use the joint rehabilitation apparatus (200; FIG. 2) with either leg.

In addition to allowing adjustment of the lateral position of the shaft sleeve (410), the leg support assembly (220) is also configured to allow adjustment of the radial distance between the drive shaft (400) and the limb attachment mechanism (430). In particular, the limb attachment mechanism (430) is coupled to the parallel rods (420) via linear glide bushings. These bushings allow the limb attachment mechanism (430) to slide along the parallel rods (420), thereby varying the radial distance from the drive shaft (400) to the limb attachment mechanism (430).

It may be desirable to vary the distance between the drive shaft (400) and the limb attachment mechanism (430) to better accommodate the attachment of a patient's limb to the joint rehabilitation apparatus (200; FIG. 2). For example, the patient is able to slide the limb attachment mechanism (430) until the limb attachment mechanism (430) is at a comfortable location on the leg. Further, because the drive shaft is not centered in relationship to the patient's knee, the radial distance from the drive shaft to the limb attachment mechanism varies as the patient's limb is moved through the flexion and extension cycle.

The leg support assembly (220) includes a locking mechanism (435) coupled to the limb attachment mechanism (430) for securing the limb attachment mechanism (430) in the proper position while the patient is mounting the machine. The limb attachment mechanism (430) also includes strap mounts (440). The strap mounts (440) are configured to allow straps (not shown) to be mounted thereto. The straps may then be used to secure the lower part of a patient's leg to be attached to the limb attachment mechanism (430).

When the lower leg is attached to the limb attachment mechanism (430), the lower leg will follow the limb attachment mechanism (430). The limb attachment mechanism (430) is rotated when the drive shaft (400) is rotated. In particular, the drive shaft (400) has a generally hexagon shape as does the inside of the shaft sleeves (410). This configuration causes the shaft sleeves (410) to rotate with the drive shaft (400). The parallel rods (420) are coupled to the shaft sleeves (410), such that as the drive shaft rotates, so do the parallel rods (420), the limb attachment mechanism (430), and the lower part of the patient's leg. As the lower part of the patient's leg is rotated, the knee joint is exercised.

As introduced, the leg support assembly (220) is coupled to the drive train assembly (230) and the electric motor (240) such that the output of the electric motor (240) drives the leg support assembly (220). The function of the drive train assembly (230) will now be discussed in more detail.

Drive Train Assembly

FIG. 5 illustrates the drive train assembly (230) and the main frame (210) with portions of the main frame (210) removed for clarity. The drive train assembly (230) shown in the present embodiment comprises a powered drive system. As seen in FIG. 5, the drive train assembly (230) includes an electric motor (240), and a transmission assembly (150) that is coupled to the drive shaft (400) of the leg support assembly (220; FIG. 2). The drive train assembly (230) is anchored to the main frame (210).

The electric motor (240) converts electrical energy from a power supply to mechanical energy exerted by a rotating shaft. An output of the electric motor (240) is mechanically coupled to an input of the transmission assembly (150). The transmission assembly (150) converts the output of the electric motor (240) into a lower speed, higher torque source of rotational mechanical energy. The transmission assembly (150) may comprise a gear reduction system to accomplish this conversion. The output of the electric motor (240) may be perpendicular to the drive shaft (400). The drive shaft (400) is mechanically coupled to an output of the transmission assembly (150).

The drive train assembly (230) may further be configured to fix the drive shaft (400), and consequentially by extension the leg support assembly (220), at a given position to allow prolonged flexion or retention of the knee joint at a set angle for a desired amount of time.

In this configuration, the drive train assembly (230) allows the speed and direction of the leg support mechanism (220: FIG. 2) to be easily and precisely controlled, thereby allowing the patient to easily and precisely control the angle of flexion and extension, and the speed and duration of each exercise cycle for the knee joint to be rehabilitated.

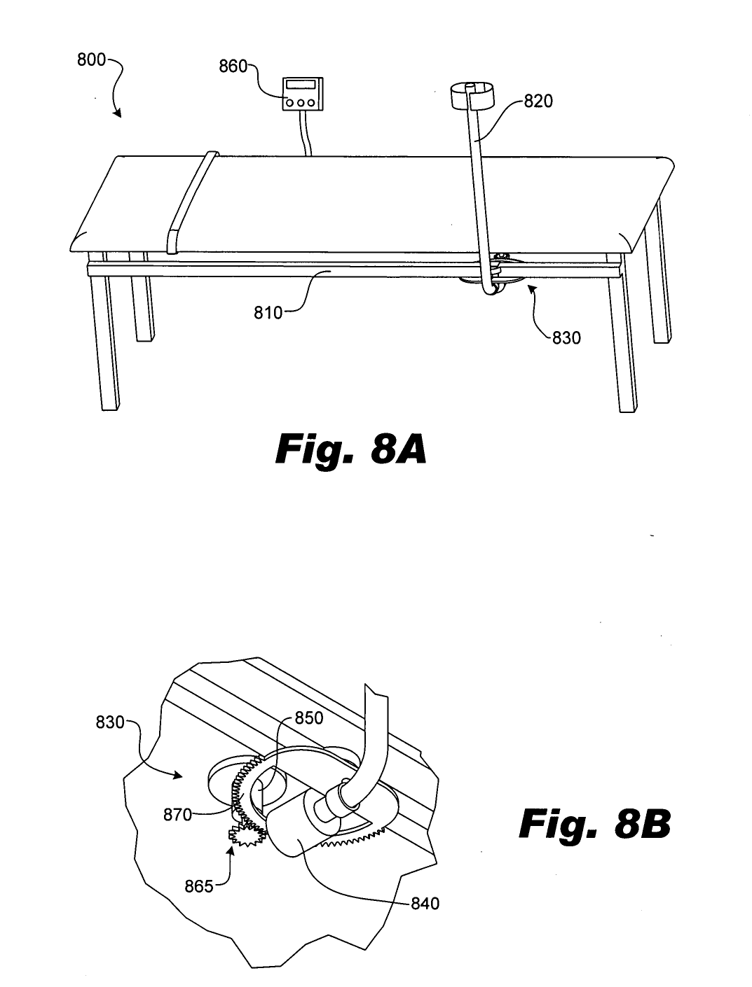

In other embodiments of the invention, a similar configuration of drive train assembly (230) may comprise a motorized mechanical energy source configured to multi-axially rotate the leg support mechanism (220: FIG. 2) or another limb support mechanism such as a shoulder support mechanism (see FIGS. 8A and 8B). In such embodiments the joint to be rehabilitated may be rotated with respect to an upper limb, a lower limb or another portion of the patient's body, such as during rehabilitation exercises for a torn shoulder rotator cuff.

Patient Operated Dynamic Control System

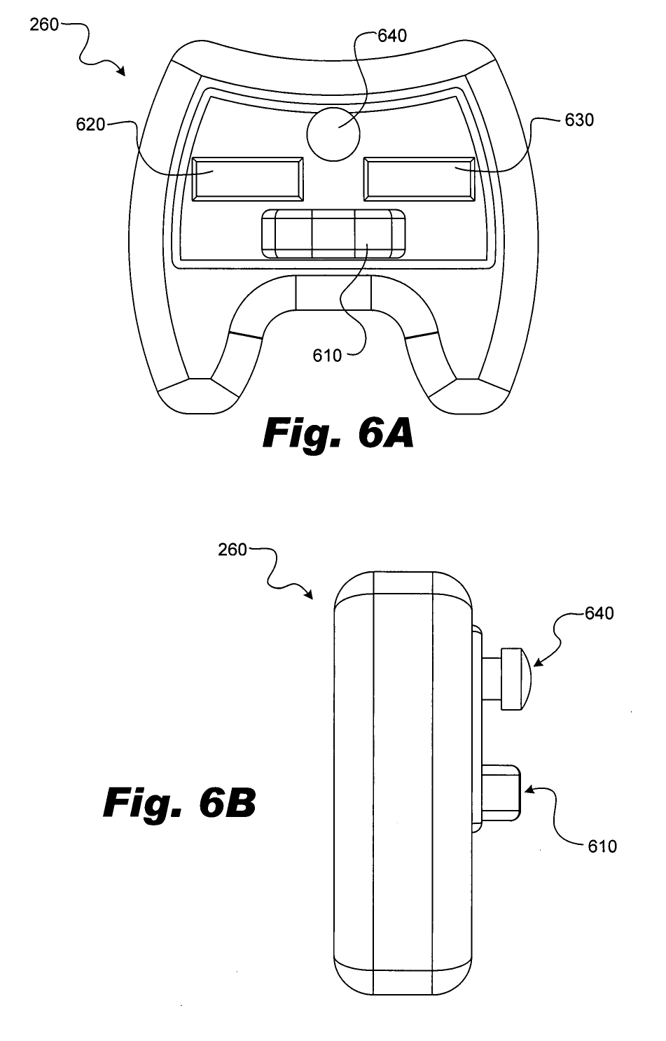

FIG. 6 illustrates the patient-operated control system (240). The patient-operated dynamic control system (260) is in electrical communication with the electric motor (240; FIG. 5) and configured to adjust positioning of the leg support assembly (220; FIG. 2) by controlling the electric motor (240; FIG. 5) in response to input from the patient. The patient-operated control system (240) may be configured to control the electric motor (240; FIG. 5) in such a way as to allow the patient dynamic control of factors such as speed, direction, and duration of flexion and extension rehabilitation cycles. In some embodiments the patient-operated dynamic control system (260) may be configured to control factors such as angle, speed, direction, and duration of joint rotation cycles.

In the exemplary patient-operated dynamic control system (260) shown, input from the patient is received by means of a control mechanism (610) such as a joystick or rocker pot to control the speed and direction of the electric motor (240; FIG. 5) and an emergency shutoff switch (640) for situations requiring the immediate ceasing of a rehabilitation cycle. Additionally, the patient-operated control system (240) may provide feedback data to the user from the optical reader (380; FIG. 3) or another feedback mechanism through display modules (620, 630). For example, one display module (620) may be configured to provide flexion, extension and/or rotation angle feedback and another display module (630) may be configured to provide time data through a clock, stopwatch, or timer display.

In some embodiments the patient-operated dynamic control system (260) may be additionally configured to display torque and speed information. The dynamic control system (260) allows the patient to view essential feedback and precisely control important factors of the rehabilitation cycle such as speed, duration, angle of rotation, and angle of flexion and extension. Furthermore, in some situations the control input from the patient may be influenced by physical stimuli experienced by the patient such as a sensation of pain or stiffness in the joint being rehabilitated.

Electrical connections between the patient-operated dynamic control system (260), the electric motor (240; FIG. 5) and the optical reader (380; FIG. 3) may be achieved through the use of flexible wiring secured to the patient-operated dynamic control system (260) and at least one point of the main frame (210; FIG. 2). The flexible wiring may allow the dynamic control system (260) to be held or mounted so that it may be viewed comfortably in any number of positions by a patient positioned on the table (340; FIG. 3).

Exemplary Apparatus

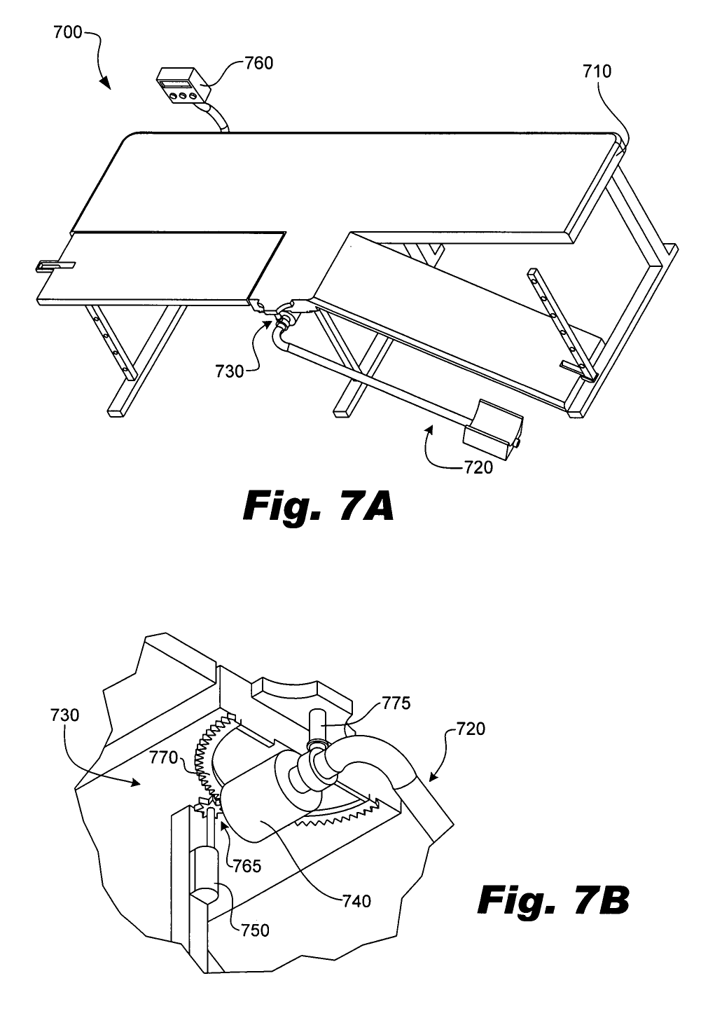

Referring now to FIGS. 7A and 7B, an exemplary apparatus (700) is shown configured to rehabilitate a hip joint by providing multi-axial motion to the joint. The apparatus comprises a main frame (710) and patient-operated dynamic control system (760) similar to those described in relation to previous figures. A patient may sit or lie down on the apparatus (700) while positioning a leg of the hip to be exercised on a leg support assembly (720). By moving the leg support assembly (720) with the patient positioned in this manner, the hip joint to be exercised is substantially isolated. The leg support assembly (720) of this embodiment is configured to provide not only flexion and extension, but also abduction motion to a hip joint. The apparatus (700) comprises a power train assembly (730) configured to provide multi-axial motion to the leg support assembly (720) and thus to the hip joint of the patient.

Referring specifically to FIG. 7B, the power train assembly (730) of this embodiment is shown in more detail. The power train assembly (730) comprises a first electric motor (740) configured to provide flexion and extension motion to the leg support assembly (720). The leg support assembly (720) may be in mechanical communication with an output shaft of the first electric motor (740).

A second electric motor (750) may be mounted to the main frame (710, FIG. 7A) and comprise an output shaft having a first gear (765) configured to rotate a second gear (770) to which the first electric motor (740) and leg support assembly (720) are attached. When the second gear (770) is rotated, the first electric motor (740) and leg support assembly (720) may rotate at a pivot (775) attached to the main frame (710, FIG. 7A) thereby providing abduction motion to the patient's hip joint when the patient's leg is mounted on the leg support assembly (720).

The degree, intensity, speed, and duration of flexion, extension, or abduction motion, along with other parameters may be adjusted by the patient using the patient-operated dynamic control system (760), as has been previously discussed in relation to other figures. Furthermore, in some embodiments, the patient-operated dynamic control system (760) may be in wireless communication with the power train assembly (730) to allow the patient greater versatility in adjusting the parameters of the joint exercise.

Referring now to FIGS. 8A and 8B, an exemplary apparatus (800) is shown configured to rehabilitate a shoulder joint by providing multi-axial motion to the joint. The apparatus comprises a main frame (810) and patient-operated dynamic control system (860) similar to those described in relation to previous figures. A patient may sit or lie down on the apparatus (800) while positioning an arm of the shoulder joint to be exercised on an arm support assembly (820). By moving the arm support assembly (820) with the patient positioned in this manner, the shoulder joint to be exercised is substantially isolated. The arm support assembly (820) of this embodiment is configured to provide flexion, extension, and abduction motion to a shoulder joint. The apparatus (800) comprises a power train assembly (830) configured to provide multi-axial motion to the arm support assembly (820) and thus to the shoulder joint of the patient.

Referring specifically to FIG. 8B, the power train assembly (830) of this embodiment is shown in more detail. The power train assembly (830) comprises a first electric motor (840) configured to provide flexion and extension motion to the arm support assembly (820). The arm support assembly (820) may be in mechanical communication with an output shaft of the first electric motor (840).

A second electric motor (850) may be mounted to the main frame (810, FIG. 8A) and comprise an output shaft having a first gear (865) configured to rotate a second gear (870) to which the first electric motor (840) and arm support assembly (820) are attached. When the second gear (870) is rotated, the first electric motor (840) and arm support assembly (820) may rotate at a pivot attached to the main frame (810, FIG. 8A) thereby providing abduction motion to the patient's shoulder joint when the patient's arm is mounted on the arm support assembly (820).

The degree, intensity, speed, and duration of flexion, extension, or abduction motion, along with other parameters may be adjusted by the patient using the patient-operated dynamic control system (860), as has been previously discussed in relation to other figures. In some embodiments, the patient-operated dynamic control system (860) may be in wireless communication with the power train assembly (860) to allow the patient greater versatility in adjusting the parameters of the joint exercise.

In conclusion, a joint rehabilitation apparatus has been described herein that allows for goal setting and attainment by the patient. The apparatus allows for full extension and substantially full flexion of a substantially fully isolated joint in addition to providing angle of flexion, extension, and/or abduction feedback to the patient. The apparatus also gives the patient precise control over the speed and duration of the flexion, extension, and/or abduction of a joint. The machine makes therapy more effective and more efficient by putting greater control in the hands of the patient.

The machine is useful for the treatment of several conditions, including, but not limited to, intra-articular knee fracture, reconstructed knee ligaments, total knee joint arthroplasty, rotator cuff injuries, tendinitis, bursitis, osteoarthritis, shoulder surgeries, shoulder fractures, shoulder replacements, joint subluxations, joint dislocations, hyperlaxity, structural impingements, functional impingements, microtrauma induced injuries, macrotrauma induced injuries, hip pointers, iliotibial band syndrome, sciatic nerve damage or injury, Legg Calvé Perthe Disease, slipped capital femoral epiphysis, hip surgeries, hip fractures, stress fractures, avascular necrosis, hip replacements, other joint conditions. and any other conditions requiring range of motion to be re-established or maintained.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A human joint rehabilitation apparatus, said apparatus comprising:
a movable platform configured to support a portion of a patient's body including said joint; and
a motorized mechanical energy source configured to move at least a portion of said platform to apply motion to said joint;
wherein said patient dynamically controls said motorized mechanical energy source to operate said motion of said joint.

2. The apparatus of claim 1, wherein said movable platform comprises a first support, a second support and at least one pivot coupled to said second support for moving said second support with respect to said first support.

3. The apparatus of claim 2, wherein said motorized mechanical energy source comprises a motor and a power transmission assembly coupling said motor to said pivot.

4. The apparatus of claim 2, wherein said first support comprises a table.

5. The apparatus of claim 2, wherein said motorized mechanical energy source is configured to axially rotate said second support with respect to said pivot.

6. The apparatus of claim 2, wherein said motorized mechanical energy source is configured to multi-axially rotate said second support.

7. The apparatus of claim 1, comprising a plurality of motorized mechanical energy sources, each of said sources being configured to move at least a portion of said platform to apply motion to said joint along different axes.

8. The apparatus of claim 1, wherein said apparatus is configured to rehabilitate a joint from the group consisting of: knee joints, shoulder joints, hip joints, elbow joints, and back joints.

9. The apparatus of claim 1, wherein said motion applied to said joint is selected from the group consisting of joint flexion, joint extension, joint rotation, joint abduction, and combinations thereof.

10. A patient-controlled joint rehabilitation apparatus, comprising:
a support table;
a motor;
a drive train assembly comprising an input mechanically coupled to said motor and an output mechanically coupled to a driveshaft;
a limb support assembly configured to provide movement of a specified joint, said limb support assembly being attached to said support table and coupled to said driveshaft; and
a patient-operated dynamic control system in communication with the motor and configured to adjust positioning of the limb support assembly by controlling said motor in response to input from said patient.

11. The apparatus of claim 10, wherein the patient-operated dynamic control assembly is configured to control said motor in such a way as to allow said patient control of speed, direction, angle, and duration of flexion, extension, and abduction rehabilitation cycles before and during said rehabilitation cycles.

12. The apparatus of claim 10, wherein said power transmission system comprises a speed reduction gear system.

13. The apparatus of claim 10, wherein the support table comprises a feedback mechanism configured to measure angular movement of the limb support assembly and provide feedback data to a display module on the patient-operated control assembly.

14. The apparatus of claim 13, wherein the patient-operated control assembly is configured to provide to said patient data selected from the group consisting of: angle of flexion, angle of extension, angle of abduction, speed of movement, direction of movement, time duration of flexion and extension exercises, torque, and combinations thereof.

15. The apparatus of claim 10, wherein said limb support mechanism comprises shaft sleeves coupled to said drive shaft, a plurality of parallel rods coupled to said shaft sleeve, and a limb support coupled to said parallel rods.

16. The apparatus of claim 15, wherein said drive shaft comprises a substantially polygonal geometry.

17. The apparatus of claim 15, and further comprising a plurality of bushings disposed at least partially between said shaft sleeve and said drive shaft.

18. The apparatus of claim 17, wherein the bushings comprise a polygonal cross-sectional geometry.

19. The apparatus of claim 15, and further comprising a plurality of straps coupled to said limb support.

20. The apparatus of claim 19, wherein said straps comprise hook and loop closure straps.

21. The apparatus of claim 15, and further comprising glide bushings located between said rods and said leg support.

22. The apparatus of claim 15, and further comprising a locking mechanism coupled to said leg support for selectively locking said leg support in position relative to said parallel rods.

23. The apparatus of claim 10, wherein said table includes a plurality of legs, a first of said legs being configured for removal and use as a transport handle, and a remainder of said legs being configured to fold flat with respect to said table.

24. The apparatus of claim 10, and further comprising at least one strap coupled to said table, said strap being configured to hold a joint during extension, flexion and abduction.

25. The apparatus of claim 10, wherein said patient-operated dynamic control system is in wireless communication with said motor.

26. A method of exercising a joint, comprising:
supporting a portion of a patient's body including a joint on a movable platform;
receiving dynamic control input from a patient through a control unit; and
dynamically powering a system to move said platform to apply motion to said joint according to said input received from said patient.

27. The method of claim 26, wherein said dynamic control input is selected from the group consisting of start commands, stop commands, direction commands, duration commands, angle of flexion commands, angle of extension commands, angle of abduction commands and combinations thereof.

28. The method of claim 26, wherein supporting a portion of said patient's body includes supporting an upper limb and supporting a lower limb while securing said upper limb relative to said movable platform to isolate said joint.

29. The method of claim 26, wherein supporting said upper limb includes strapping said upper limb to a support.

30. The method of claim 26, further comprising selectively pausing said application of motion to said joint at a desired position.

31. The method of claim 26, further comprising providing feedback data to said patient through the control unit.

32. The method of claim 31, wherein said input from said patient is at least partially determined from said feedback data.

33. The method of claim 26, wherein said input from said patient is at least partially determined according to physical stimuli experienced by said patient.
